(19) United States
(12) Patent Application Publication
(10) Pub. No.: US 2025/0326023 A1
(43) Pub. Date: Oct. 23, 2025

(54) UNLOADING METHOD AND MECHANICAL UNLOADING ASSEMBLY FOR UNLOADING A PROCESSED PRODUCT OF A WORKPIECE PROCESSING METHOD, MANUFACTURING METHOD, AND MECHANICAL MANUFACTURING ASSEMBLY

(71) Applicant: TRUMPF Werkzeugmaschinen SE + Co. KG, Ditzingen (DE)

(72) Inventors: Carsten Böhme, Pulsnitz (DE); Andreas Schmidt, Hochkirch (DE); Patrick Wowtscherk, Neschwitz (DE); Markus Wowtscherk, Ralbitz-Rosenthal OT Schönau (DE)

(21) Appl. No.: 19/181,386

(22) Filed: Apr. 17, 2025

Related U.S. Application Data
(63) Continuation of application No. PCT/EP2023/078644, filed on Oct. 16, 2023.

(30) Foreign Application Priority Data
Oct. 18, 2022 (DE) 10 2022 127 169.2

(51) Int. Cl. B21D 45/02

(52) U.S. Cl. CPC B21D 45/02

(57) ABSTRACT

An unloading method unloads a sheet metal machining product produced on a sheet metal working machine. The method includes: supplying the machining product to a supply device for unloading with a position and an orientation defined in a coordinate system of the supply device; moving an unloading member of the unloading device with a transfer movement into a transfer position on the machining product supplied to the supply device for unloading; calibrating, before the machining product is unloaded from the supply device, the numerical unloading control of the unloading device; and unloading the machining product from the supply device by the unloading device. The unloading of the machining product is controlled by the programmable numerical control which includes the programmable numerical unloading control of the unloading device and in which the coordinate system of the supply device and the similar coordinate system of the numerical unloading control are stored.

### CROSS REFERENCE TO RELATED APPLICATIONS

This application is a continuation of International Application No. PCT/EP2023/078644 (WO 2024/083727 A1), filed on Oct. 16, 2023, and claims benefit to German Patent Application No. DE 10 2022 127 169.2, filed on Oct. 18, 2022. The aforementioned applications are hereby incorporated by reference herein.

### FIELD

The invention relates to an unloading method for unloading a machining product of a workpiece machining process. The invention also relates to a mechanical unloading arrangement for carrying out the aforementioned unloading method, as well as a manufacturing method, in the course of which the aforementioned unloading method is carried out, and a mechanical manufacturing arrangement for carrying out this manufacturing method.

### BACKGROUND

Prior art of the type in question is known from DE 10 2016 115 987 A1.

In the case of the prior art, an item is unloaded from a conveyor by means of a robot in an automated manner. For this purpose, a three-dimensional Cartesian coordinate system for the conveyor and a three-dimensional Cartesian and thus similar coordinate system for the robot are stored in a numerical control. The position and the orientation of an item to be unloaded from the conveyor in the coordinate system for the conveyor is acquired by means of image processing. The position and the orientation of the item to be unloaded in the coordinate system for the robot are determined based on the position and the orientation of the item to be unloaded in the coordinate system for the conveyor. On the basis of the position and the orientation of the item to be unloaded in the coordinate system of the robot, a robot gripper is moved under numerical control to the item to be unloaded on the conveyor in order to pick up the item to be unloaded.

### SUMMARY

In an embodiment, the present disclosure provides an unloading method for unloading a sheet metal machining product produced on a sheet metal working machine. The method includes: supplying the machining product to a supply device for unloading with a position and an orientation defined in a coordinate system of the supply device, wherein a position and an orientation of the machining product supplied for unloading in the coordinate system of the supply device are derived from the position and the orientation of the machining product supplied for unloading in the coordinate system of a numerical unloading control; moving an unloading member of the unloading device with a transfer movement into a transfer position on the machining product supplied to the supply device for unloading, wherein the transfer movement of the unloading member is controlled by a programmable numerical unloading control on the basis of the position and the orientation of the machining product supplied for unloading in a coordinate system of the numerical unloading control; and calibrating, before the machining product is unloaded from the supply device, the numerical unloading control of the unloading device. The calibrating includes: supplying a reference object to the supply device, which reference object includes a marking that represents the coordinate system of the supply device and the position and the orientation of which are defined in the coordinate system of the supply device; deriving a position and an orientation of the marking of the reference object supplied for unloading in the coordinate system of the numerical unloading control as a derived position and a derived orientation from the position and the orientation of the marking of the reference object supplied for unloading in the coordinate system of the supply device; representing the marking of the reference object supplied to the supply device for unloading in the coordinate system of the numerical unloading control; comparing the position and the orientation of the representation of the marking of the reference object in the coordinate system of the numerical unloading control with the derived position and the derived orientation of the marking of the reference object in the coordinate system of the numerical unloading control; and adjusting the coordinate system of the numerical unloading control if the position and/or orientation of the representation of the marking of the reference object differs from the derived position or the derived orientation of the marking of the reference object in the coordinate system of the numerical unloading control, by bringing the derived position and/or the derived orientation of the marking of the reference object into agreement with the position or the orientation, respectively, of the representation of the marking of the reference object. The method also includes unloading the machining product from the supply device by the unloading device, wherein the unloading of the machining product is controlled by the programmable numerical control which includes the programmable numerical unloading control of the unloading device and in which the coordinate system of the supply device and the similar coordinate system of the numerical unloading control are stored. The machining product supplied by the supply device for unloading is transferred by the unloading member moved into the transfer position and the machining product transferred by the unloading member is unloaded from the supply device with an unloading movement of the unloading member. After calibrating the numerical unloading control of the unloading device, the position and the orientation of the machining product supplied for unloading in the adjusted coordinate system of the numerical unloading control are derived from the position and the orientation of the machining product supplied for unloading in the coordinate system of the supply device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a numerically controlled mechanical arrangement for manufacturing sheet metal having a laser flatbed machine and a mechanical unloading arrangement according to an embodiment of the present invention;

FIG. 2 shows a highly schematized top view of the workpiece support of the mechanical arrangement according to FIG. 1 when calibrating the numerical control of the mechanical arrangement according to an embodiment of the present invention;

FIG. 3 and FIG. 4 show illustrations representing the processes for calibrating the numerical control of the mechanical arrangement according to FIG. 1;

FIG. 5 and FIG. 6 show exemplary possibilities for acquiring a marking on a reference sheet when calibrating the numerical control of the mechanical arrangement according to FIG. 1; and

FIG. 7 shows a numerically controlled mechanical arrangement for manufacturing sheet metal from a coil according to an embodiment of the present invention.

### DETAILED DESCRIPTION

An embodiment of the present invention relates to an unloading method for unloading a machining product of a workpiece machining process, and in a particular embodiment for unloading a sheet metal machining product produced on a sheet metal working machine, wherein the machining product is unloaded from a supply device by means of an unloading device, wherein the unloading of the machining product is controlled by means of a programmable numerical control which comprises a programmable numerical unloading control of the unloading device and in which a coordinate system of the supply device and a similar coordinate system of the numerical unloading control are stored, wherein the machining product is supplied to the supply device for unloading with a position and an orientation defined in the coordinate system of the supply device, wherein a position and an orientation of the machining product supplied for unloading in the coordinate system of the supply device are derived from the position and the orientation of the machining product supplied for unloading in the coordinate system of the numerical unloading control, wherein an unloading member of the unloading device is moved with a transfer movement into a transfer position on the machining product supplied to the supply device for unloading, wherein the transfer movement of the unloading member is controlled by the numerical unloading control on the basis of the position and the orientation of the machining product supplied for unloading in the coordinate system of the numerical unloading control, and wherein the machining product supplied by the supply device for unloading is transferred by the unloading member moved into the transfer position and the machining product transferred by the unloading member is unloaded from the supply device with an unloading movement of the unloading member.

Embodiments of the present invention can enable the long-term, reliable unloading of workpieces from a supply device with as little effort as possible.

Embodiments of the present invention can achieve this with the unloading method, the manufacturing method, the mechanical unloading arrangement, and the mechanical manufacturing arrangement.

In an embodiment of the present invention, before a machining product is unloaded from a supply device, the numerical unloading control of the unloading device used to unload machining products is first calibrated. In this regard, the coordinate system of the numerical unloading control is adapted to the coordinate system of the supply device, which is intended as the leading coordinate system. The adjustment of the coordinate system of the numerical unloading control according to the embodiment of the present invention ensures that, when machining products are unloaded after the calibration of the numerical unloading control, the position and the orientation of the machining product to be unloaded, which serve as the basis for controlling the transfer movement of the unloading member, in the coordinate system of the numerical unloading control, exactly reflect the actual position and actual orientation of the machining product to be unloaded in the coordinate system of the numerical unloading control.

When deriving the position and the orientation of a workpiece to be machined in the coordinate system of the numerical unloading control from the coordinate system of the supply device, a certain mutual positioning and orientation of the supply device and the unloading device is often required. In such cases, the installation of the unloading arrangement according to an embodiment of the present invention and/or the manufacturing arrangement according to an embodiment of the present invention is simplified due to the calibration of the numerical unloading control according to an embodiment of the present invention, in that any inaccuracies in the mutual arrangement of the supply device and the unloading device can be compensated for by the adaptation of the coordinate system of the numerical unloading control with the coordinate system of the supply device, which is carried out before the unloading arrangement and/or the manufacturing arrangement is put into operation.

In a preferred embodiment of the present invention, two-or three-axis Cartesian coordinate systems are provided as the coordinate systems of the supply device and the numerical unloading control.

A reference sheet can be used as the reference object when calibrating the numerical unloading control.

In a particular embodiment, a marking can be applied to a reference sheet by means of separative machining, which marking represents the coordinate system of the supply device.

In a preferred embodiment of the manufacturing method and the manufacturing arrangement according to an embodiment of the present invention, the machining device is used to produce the marking of the reference object, which is used for the workpiece machining process as part of a manufacturing process following the calibration of the numerical unloading control.

In a further development of an embodiment of the manufacturing method according to the present invention, the coordinate system of the supply device or the workpiece support is formed by a coordinate system of a numerical machining control of the machining device intended for the workpiece machining process.

In another preferred variant of an embodiment of the manufacturing method according to the present invention, the workpiece during its machining and the machining product produced by the workpiece machining process are stored by a workpiece support designed as a supply device. After the workpiece machining process, the machining product is moved by means of a transfer movement of the workpiece support from a starting position to a target position and supplied there for unloading by means of the unloading device with a position and an orientation defined in the coordinate system of the workpiece support provided as a supply device.

In this regard, the transfer movement of the workpiece support is, in a preferred embodiment, carried out by means of a support drive which has a numerical drive control with a coordinate system that is provided as the coordinate system of the workpiece support provided as the supply device. In order for the machining product, which is moved together with the workpiece support, to be arranged in the target position, in which it is supplied for unloading, in the coordinate system of the numerical drive control and thus in the coordinate system of the workpiece support provided as a supply device, with a position and an orientation that correspond to the actual position and the actual orientation of the machining product, the numerical support drive control is calibrated before moving a machining product from the starting position to the target position. The numerical support drive control of the manufacturing arrangement according to an embodiment of the present invention is constructed for this purpose in accordance with the numerical unloading control of the unloading arrangement according to an embodiment of the present invention and accordingly comprises a calculation unit, an acquisition device, a comparison unit and an evaluation unit.

In a preferred embodiment of the present invention, one and the same calculation unit and/or one and the same acquisition device and/or one and the same comparison unit and/or one and the same evaluation unit are used for the calibration of the numerical support drive control and for the calibration of the numerical unloading control.

In a further development of an embodiment of the present invention, the numerical support drive control is formed by the numerical machining control of the machining device of the manufacturing arrangement according to an embodiment of the present invention.

In a preferred embodiment, the reference object used to calibrate the numerical drive control of the workpiece support is also used to calibrate the numerical unloading control.

In a further preferred embodiment of the manufacturing method according to an embodiment of the present invention, the machining product, after being unloaded from the workpiece support by means of the unloading device, is deposited at a deposit location with a position and an orientation defined in the coordinate system of the unloading control. After the machining product has been transferred from the unloading device in a defined position and orientation, the machining product can also be deposited in a defined position and orientation at the deposit location.

According to embodiment of the present invention, the manufacturing method and the manufacturing arrangement according to an embodiment of the present invention are designed, in particular, for sheet metal machining, for example for separative sheet metal machining, from a coil.

The embodiments of the present invention will be explained in more detail below on the basis of exemplary schematic illustrations.

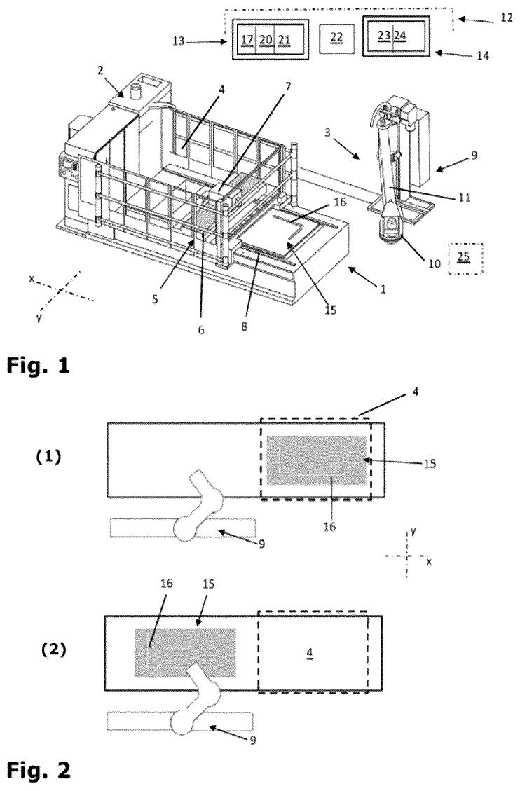

According to FIG. 1, a mechanical manufacturing arrangement 1 comprises a laser flatbed machine 2 as a machining device and also a mechanical unloading arrangement 3.

The laser flatbed machine 2 serves as a separating device for the separative machining of metal sheets and for this purpose has a workspace 4 in which a laser cutting unit 5 of conventional design is arranged. The laser cutting unit 5 comprises a portal structure 6 that can be moved along an x-axis inside of the workspace 4 and that, in turn, guides a laser cutting head 7 such that it can be moved along a y-axis that runs perpendicular to the x-axis.

A metal sheet to be machined is stored during the separative machining by means of the laser cutting head 7 on a workpiece pallet 8 serving as a workpiece support. Prior to the separative sheet metal machining, the workpiece pallet 8 is loaded with the sheet metal outside of the workspace 4 of the laser flatbed machine 2 and then moved together with the sheet metal longitudinally along the x-axis into the workspace 4. After the sheet metal machining is complete, the workpiece pallet 8, with the sheet metal machining product produced during the separating sheet metal machining and with a skeleton also produced during the sheet metal machining, is moved out of the workspace 4 of the laser flatbed machine 2 in the x-direction back to its initial position outside of the workspace 4. The workpiece pallet 8 is shown in FIG. 1 outside of the workspace 4. The movements of the workpiece pallet 8 are carried out by means of a motorized pallet or support drive, which is controlled by the machining control.

The workpiece pallet 8 is also a part of the mechanical unloading arrangement 3. As part of this function, the workpiece pallet 8, which is arranged outside of the workspace 4 of the laser flatbed machine 2, forms a supply device at which the sheet metal machining product arranged on the workpiece pallet 8 is supplied for unloading by means of an unloading robot 9 provided as an unloading device of the mechanical unloading arrangement 3.

The unloading robot 9 is prepared with a defined spatial assignment with respect to the laser flatbed machine 2 and thus also with a defined spatial assignment with respect to the workpiece pallet 8 adjacent to the laser flatbed machine 2. As an unloading member, the unloading robot 9 has a gripper head 10, which is mounted on an extension arm 11 of the unloading robot 9 and can be moved with a transfer movement into a transfer position on the sheet metal machining product supplied on the workpiece support 8.

All essential processes in the mechanical manufacturing arrangement 1 are controlled by a programmable numerical arrangement control 12, which in turn comprises a numerical machining control 13 of the laser flatbed machine 2 and a numerical unloading control 14 of the unloading robot 9. The numerical machining control 13 also controls the movements of the workpiece pallet 8 longitudinally of the x-axis.

A coordinate system in the form of a Cartesian coordinate system with coordinate axes running in the x-direction and y-direction is stored in both the numerical machining control 13 and the numerical unloading control 14.

The position and the orientation in which a sheet metal machining product is arranged in a starting position after completion of the separative sheet metal machining inside of the workspace 4 of the laser flatbed machine 2 are defined in the coordinate system of the numerical machining control 13. Starting from the starting position, the sheet metal machining product is moved with a transfer movement of the workpiece pallet 8 over a defined path length in the x-direction to a target position in which the sheet metal machining product is arranged together with the workpiece pallet 8 outside of the workspace 4 of the laser flatbed machine 2 and is ready for unloading by means of the unloading robot 9. The transfer movement of the workpiece pallet 8 is carried out by means of the motorized support or pallet drive, which is controlled, in this regard, by the machining control 13, in particular by a numerical support drive control of the machining control 13.

Once the position and the orientation of the sheet metal machining product in the starting position are defined in the coordinate system of the numerical machining control 13 based on the corresponding programming of the machining control, and once the direction and path length of the movement of the sheet metal machining product from the starting position to the target position in the coordinate system of the numerical machining control 13 are also defined by programming the machining control 13, the position and the orientation of the sheet metal machining product supplied outside of the workspace 4 for unloading are also defined in the coordinate system of the numerical machining control 13.

Due to the defined mutual spatial assignment of the laser flatbed machine 2 on the one hand and the unloading robot 9 on the other, a position and an orientation of the sheet metal machining product in the coordinate system of the numerical unloading control 14 can be derived from the position and the orientation of the sheet metal machining product supplied at the laser flatbed machine 2 for unloading in the coordinate system of the numerical machining control 13.

On the basis of the position and the orientation of the sheet metal machining product in the coordinate system of the numerical unloading control 14, the gripper head 10 of the unloading robot 9 is moved in a numerically controlled manner with a transfer movement to a transfer position at the sheet metal machining product supplied for unloading. The gripper head 10, which has been moved into the transfer position, picks up the sheet metal machining product and then unloads it from the workpiece pallet 8 with an unloading movement.

In practice, it is conceivable that the position and the orientation of the sheet metal machining product supplied for unloading, derived from the position and the orientation of the sheet metal machining product after the separative sheet metal machining has been completed, does not reflect the actual circumstances in the coordinate system of the numerical machining control 13 in the coordinate system of the numerical machining control 13. The reason for such a deviation of the derived circumstances from the actual circumstances may be, in particular, an unwanted skewing of the movement axis of the motorized drive of the workpiece pallet 8 used for the movement of the sheet metal machining product from the starting position to the target position and/or an unwanted reorientation of the sheet metal machining product during the movement from the starting position to the target position.

Additionally or alternatively, it is possible that the position and the orientation of the sheet metal machining product derived from the position and the orientation of the sheet metal machining product supplied for unloading in the coordinate system of the numerical machining control 13 in the coordinate system of the numerical unloading control 14 does not correctly reflect the actual circumstances in the coordinate system of the numerical unloading control 14. Such a deviation of the derived circumstances from the actual circumstances may be caused, for example, by the fact that the mutual spatial assignment of the unloading robot 9 and the laser flatbed machine 2 differs from that assignment which was used as a basis for deriving the position and the orientation of the sheet metal machining product in the coordinate system of the unloading control 14 from the position and the orientation of the sheet metal machining product supplied at the workpiece pallet 8 for unloading in the coordinate system of the machining control 13.

In order to compensate for deviations of the type mentioned above using control-related measures, the numerical control system 12 is calibrated before the start of a manufacturing process.

A reference sheet 15 is used as a reference object to calibrate the numerical arrangement control 12. The reference sheet 15 is manufactured by providing a marking 16 on a reference sheet blank arranged on the workpiece pallet 8 by means of the laser cutting head 7 by means of separative machining, which marking represents the coordinate system of the numerical machining control 13. Accordingly, the marking 16 has an X-leg and a Y-leg, wherein the X-leg runs in the x-direction and the Y-leg runs in the y-direction.

After the marking 16 has been produced, the reference sheet 15 is in a starting position inside of the workspace 4 of the laser flatbed machine 2 (see partial view (1) of FIG. 2). The position and the orientation of the marking 16 on the reference sheet 15 arranged in the starting position are defined in the coordinate system of the numerical machining control 13.

the position and the orientation of the marking 16 in the coordinate system of the numerical machining control 13 are derived from the position and the orientation of the marking 16 on the reference sheet 15 arranged in the starting position in the coordinate system of the numerical machining control 13 by means of a calculation unit 17 of the numerical machining control 13, which are to be expected for the marking 16 after the reference sheet 15 has been moved by means of the motorized drive of the workpiece pallet 8 from the starting position with a defined movement in the x-direction into a target position outside of the workspace 4 of the laser flatbed machine.

After the reference sheet 15 has moved to the target position (see partial view (2) of FIG. 2), the actual position and the actual orientation of the marking 16 in the coordinate system of the numerical machining control 13 are acquired on the reference sheet 15 arranged in the target position. For this purpose, an optical sensor 18 designed as a camera or laser sensor and provided as an acquisition device can be used, which is attached to the unloading robot 9 (FIG. 5) or a corresponding acquisition device in the form of an optical sensor 19 on the housing of the laser flatbed machine 2 (FIG. 6) can be used.

The actual position and the actual orientation of the marking 16 on the reference sheet 15 arranged in the target position, acquired by means of the optical sensor 18 or the optical sensor 19, are compared in a comparison unit 20 of the numerical machining control 13 with the derived position and the derived orientation of the marking 16 in the coordinate system of the numerical machining control 13.

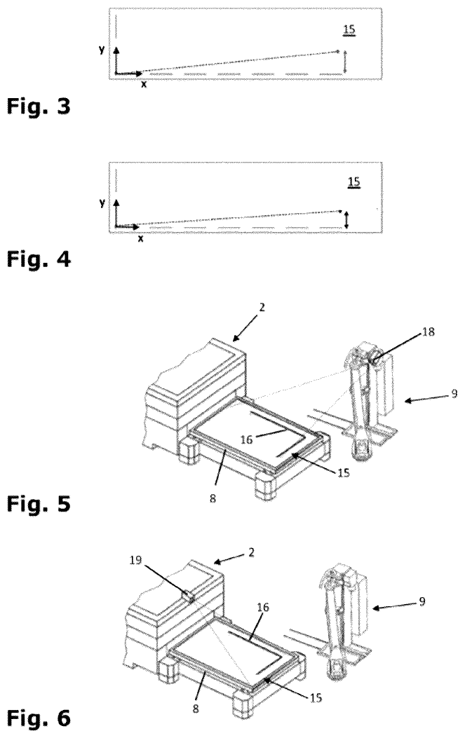

An exemplary result of this comparison is shown in FIG. 3. The dotted line between the two points on the reference sheet 15 in FIG. 3 shows the actual course of the X-leg of the marking 16 in the coordinate system of the numerical machining control 13, running longitudinally along the x-axis of the coordinate system of the machining control 13. Since the Y-leg of marking 16 runs at a right angle to the X-leg, the course of the Y-leg and thus the orientation of marking 16 are also known from the course of the X-leg. The position of marking 16 is defined by the position of the common origin of the X-leg and the Y-leg.

The dashed lines show the courses of the X-leg and the Y-leg of the marking 16 on the reference sheet 15 moved to the target position in the coordinate system of the numerical machining control 13, which are derived from the circumstances in the starting position of the reference sheet 15. The origin of the derived X and Y-legs coincides with the origin of the X and Y-legs acquired by means of the sensors 18 and 19.

According to FIG. 3, the actual orientation of the marking 16 on the reference sheet 15 arranged in the target position in the coordinate system of the numerical machining control 13 differs from the derived orientation of the marking 16 in the coordinate system of the numerical machining control 13. The deviation of the actual from the derived orientation of marking 16 is illustrated in FIG. 3 by a double arrow.

Due to the deviation, an evaluation unit 21 of the numerical machining control 13 generates a correction variable for the numerical machining control 13. This correction variable is used in the future derivation of the position and the orientation of the sheet metal machining product arranged in the target position from the position and the orientation of the sheet metal machining product arranged in the starting position. Consequently, for future machining processes, the derived position and orientation of the sheet metal machining product supplied for unloading correctly represent the actual circumstances in the coordinate system of the numerical machining control 13.

The derived position and orientation of the marking 16 can also be represented on the reference sheet 15 by means of a light-emitting transmitter with the X and Y-legs shown dashed in FIG. 3. The deviation of the actual from the derived orientation of the marking 16, as illustrated in FIG. 3 by the double arrow, can then be measured on the reference sheet 15 and the correction variable for the numerical machining control 13 can be generated on the basis of the measurement result.

The calibration of the numerical unloading control 14 follows the calibration of the numerical machining control 13.

A calculation unit 22 of the numerical arrangement control 12, which is provided for this purpose, derives a position and an orientation of the marking 16 on the reference sheet 15 arranged in the target position in the coordinate system of the numerical unloading control 14 from the position and the orientation corresponding to the actual circumstances of the marking 16 on the reference sheet 15, which is arranged in the target position and supplied for unloading, in the coordinate system of the numerical machining control 13.

Subsequently, or simultaneously, the marking 16 on the reference sheet 15 supplied for unloading is represented in the coordinate system of the numerical unloading control 14 by means of the optical sensor 18 on the unloading robot 9 or by means of the optical sensor 19 on the housing of the laser flatbed machine 2. the position and the orientation of the representation of the marking 16 of the reference sheet 15 in the coordinate system of the numerical unloading control 14 are compared with the derived position and the derived orientation of the marking 16 of the reference sheet 15 in the coordinate system of the numerical unloading control 14 by means of a comparison unit 23 of the numerical unloading control 14. The method used for comparing the actual and derived circumstances in the coordinate system of numerical machining control 13 is used here.

An exemplary result of such a comparison is shown in FIG. 4.

In the example shown, the actual orientation of the marking 16 in the coordinate system of the numerical unloading control 14 and the derived orientation of the marking 16 in the coordinate system of the numerical unloading control 14 differ from one another. The deviation is shown in FIG. 4 by a double arrow.

Due to the determined deviation of the actual circumstances in the coordinate system of the numerical unloading control 14 from the derived circumstances, the coordinate system of the numerical unloading control 14 is adjusted by means of an evaluation unit 24 of the numerical unloading control 14 bringing the derived orientation of the marking 16 of the reference sheet 15 in the coordinate system of the numerical unloading control 14 into agreement with the orientation of the representation of the marking 16 of the reference sheet 15 in the coordinate system of the numerical unloading control 14.

In later machining processes, the position and the orientation of the sheet metal machining product supplied for unloading in the adjusted coordinate system of the numerical unloading control 14 are derived from the position and the orientation of the sheet metal machining product supplied for unloading in the coordinate system of the numerical machining control 13.

A light-emitting transmitter can also be used to visualize the derived circumstances when calibrating the numerical unloading control 14. The light-emitting transmitter can represent the derived position and orientation of the marking 16 on the reference sheet 15 with the dashed X and Y-legs in FIG. 4. The deviation of the actual from the derived orientation of the marking 16, as illustrated in FIG. 4 by the double arrow, can be measured and a correction variable for the numerical unloading control 14 can be generated on the basis of the measurement result.

On the basis of the calibration of the numerical arrangement control 12, sheet metal machining products are unloaded in subsequent manufacturing processes by means of the unloading robot 9 with a position and an orientation corresponding to the actual circumstances in the coordinate system of the numerical unloading control 14. This makes it possible, for example, to deposit a sheet metal machining product that has been unloaded from the workpiece pallet 8 in a defined position and with a defined orientation at a deposit location 25, which is shown in a highly schematized manner in FIG. 1.

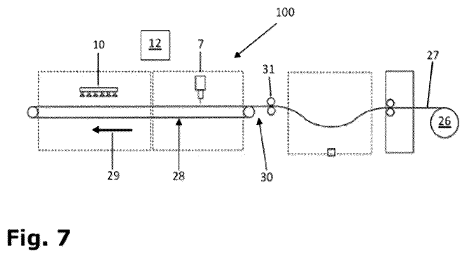

FIG. 7 shows a mechanical manufacturing arrangement 100 for the separative machining of a sheet metal strip 27 unwound from a coil 26.

Instead of the workpiece pallet 8 of the manufacturing arrangement 1, the manufacturing arrangement 100 has an endlessly circulating conveyor belt 28 as a supply device. The movement of the sheet metal strip 27 in a feed direction 29 is effected by means of a feed drive 30, which is formed by the drive of the conveyor belt 28 and a feed roller pair 31. A section of the sheet metal strip 27, which is leading in the feed direction 29 and is provided with the marking 16, serves as the reference sheet for calibrating the numerical arrangement control 12 of the manufacturing arrangement 100.

The marking 16 is also created on the manufacturing arrangement 100 by means of a laser cutting head 7 by separative machining of a reference object blank, in this case by separative machining of the relevant section of the sheet metal strip 27, wherein the laser cutting head 7 is also used for sheet metal machining in the course of a manufacturing process following the calibration of the arrangement control 12.

An unloading robot with a gripper head 10, controlled by means of an unloading control, is also provided in the case of the manufacturing arrangement 100 to unload the reference sheet and the sheet metal machining products produced by means of the laser cutting head 7.

The same method is used to calibrate the numerical arrangement control 12 of the manufacturing arrangement 100 as for the calibration of the manufacturing arrangement 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An unloading method for unloading a sheet metal machining product produced on a sheet metal working machine, comprising:
supplying the machining product to a supply device for unloading with a position and an orientation defined in a coordinate system of the supply device, wherein a position and an orientation of the machining product supplied for unloading in the coordinate system of the supply device are derived from the position and the orientation of the machining product supplied for unloading in the coordinate system of a numerical unloading control;
moving an unloading member of the unloading device with a transfer movement into a transfer position on the machining product supplied to the supply device for unloading, wherein the transfer movement of the unloading member is controlled by a programmable numerical unloading control on the basis of the position and the orientation of the machining product supplied for unloading in a coordinate system of the numerical unloading control;
calibrating, before the machining product is unloaded from the supply device, the numerical unloading control of the unloading device, comprising:
supplying a reference object to the supply device, which reference object comprises a marking that represents the coordinate system of the supply device and the position and the orientation of which are defined in the coordinate system of the supply device;
deriving a position and an orientation of the marking of the reference object supplied for unloading in the coordinate system of the numerical unloading control as a derived position and a derived orientation from the position and the orientation of the marking of the reference object supplied for unloading in the coordinate system of the supply device;
representing the marking of the reference object supplied to the supply device for unloading in the coordinate system of the numerical unloading control;
comparing the position and the orientation of the representation of the marking of the reference object in the coordinate system of the numerical unloading control with the derived position and the derived orientation of the marking of the reference object in the coordinate system of the numerical unloading control; and
adjusting the coordinate system of the numerical unloading control if the position and/or orientation of the representation of the marking of the reference object differs from the derived position or the derived orientation of the marking of the reference object in the coordinate system of the numerical unloading control, by bringing the derived position and/or the derived orientation of the marking of the reference object into agreement with the position or the orientation, respectively, of the representation of the marking of the reference object, and
unloading the machining product from the supply device by the unloading device, wherein the unloading of the machining product is controlled by the programmable numerical control which comprises the programmable numerical unloading control of the unloading device and in which the coordinate system of the supply device and the similar coordinate system of the numerical unloading control are stored,
wherein the machining product supplied by the supply device for unloading is transferred by the unloading member moved into the transfer position and the machining product transferred by the unloading member is unloaded from the supply device with an unloading movement of the unloading member, and
wherein after calibrating the numerical unloading control of the unloading device, the position and the orientation of the machining product supplied for unloading in the adjusted coordinate system of the numerical unloading control are derived from the position and the orientation of the machining product supplied for unloading in the coordinate system of the supply device.

2. The unloading method according to claim 1, wherein the coordinate system of the supply device and the coordinate system of the numerical unloading control are Cartesian coordinate systems, and wherein the marking of the reference object supplied at the supply device forms two lines that run at a right angle to one another in a plane that extends parallel to a coordinate plane of the coordinate system of the supply device and parallel to a coordinate plane of the coordinate system of the numerical unloading control.

3. The unloading method according to claim 1, wherein a reference sheet provided with the marking is used as the reference object.

4. The unloading method according to claim 1, wherein the marking of the reference object is produced by means of separative machining of a reference object blank.

5. A manufacturing method, comprising:
machining, by a machining device, a workpiece;
after the workpiece has been machined, supplying a machining product produced by machining the workpiece to a workpiece support provided as a supply device for the purpose of unloading; and
unloading the machining product supplied to the workpiece support for the purpose of unloading from the workpiece support by an unloading device by carrying out an unloading method,
wherein the machining product supplied to the workpiece support for the purpose of unloading is unloaded from the workpiece support by carrying out the unloading method according to claim 1.

6. The manufacturing method according to claim 5, wherein the coordinate system of the workpiece support is formed by the coordinate system of the numerical machining control of the machining device.

7. The manufacturing method according to claim 5, wherein the reference object is produced by means of the machining device by providing a reference object blank with the marking using the machining device.

8. The manufacturing method according to claim 7, wherein a laser separating device is provided as the machining device, by which the workpiece is subjected to separative machining, and wherein the machining product supplied to the workpiece support for the purpose of unloading is unloaded from the workpiece support by carrying out the unloading method wherein the marking of the reference object is produced by means of separative machining of the reference object blank by using the separating device provided as the machining device.

9. The manufacturing method according to claim 5, wherein the workpiece is held in position during machining and the machining product is held in position after the workpiece has been machined, and wherein the machining product is moved from a starting position to a target position after the workpiece has been machined by means of a transfer movement of the workpiece support, in which target position the machining product is supplied to the workpiece support for unloading, wherein the machining product is arranged in the starting position and in the target position with a position and an orientation that are defined in the coordinate system of the workpiece support.

10. The manufacturing method according to claim 9, wherein the transfer movement of the workpiece support is carried out by a support drive which has a numerical support drive control with a coordinate system that forms the coordinate system of the workpiece support, wherein the machining product is arranged in the starting position with a respective position and a respective orientation that are defined in the coordinate system of the numerical support drive control, wherein a position and an orientation of the machining product arranged in the target position in the coordinate system of the numerical support drive control are derived from the respective position and the respective orientation of the machining product arranged in the starting position in the coordinate system of the numerical support drive control, and wherein before the machining product is moved from the starting position to the target position, the numerical support drive control is calibrated, comprising:
arranging the reference object in the starting position on the workpiece support, which reference object has the marking that represents the coordinate system of the numerical support drive control and the position and the orientation of which are defined in the coordinate system of the numerical support drive control;
deriving, from the position and the orientation of the marking of the reference object arranged in the starting position in the coordinate system of the numerical support drive control, a position and an orientation of the marking, which have the marking in the coordinate system of the numerical support drive control when the reference object is arranged in a target position, as the derived position and the derived orientation;
moving the reference object provided with the marking from the starting position to the target position;
acquiring the position and the orientation of the marking in the coordinate system of the numerical support drive control when the reference object is arranged in the target position, as an actual position and an actual orientation of the marking;
comparing the actual position and the actual orientation of the marking in the coordinate system of the numerical support drive control with the derived position and the derived orientation of the marking in the coordinate system of the numerical support drive control; and
generating a correction variable for the numerical support drive control in the event of a deviation of the actual position and the actual orientation of the marking from the derived position and the derived orientation of the marking for use in deriving the position and the orientation of the machining product arranged in the target position in the coordinate system of the numerical support drive control from the position and the orientation of the machining product arranged in the starting position in the coordinate system of the numerical support drive control.

11. The manufacturing method according to claim 10, wherein the numerical support drive control is formed by the numerical machining control of the machining device.

12. The manufacturing method according to claim 5, wherein the reference object for calibrating the numerical support drive control is used as a reference object for calibrating the numerical unloading control.

13. The manufacturing method according to claim 5, wherein the machining product, after being unloaded from the workpiece support by the unloading device, is deposited at a deposit location with a deposit position and a deposit orientation defined in the coordinate system of the unloading control.

14. The manufacturing method according to claim 5, wherein a section of a sheet metal strip unwound from a coil is machined as the workpiece.

15. A mechanical unloading arrangement for unloading a sheet metal machining product produced on a sheet metal working machine, comprising:
a supply device and an unloading device, wherein the machining product is configured to be supplied to the supply device for the purpose of unloading and is configured to be unloaded from the supply device by the unloading device,
a programmable numerical control which comprises a programmable numerical unloading control of the unloading device and in which a coordinate system of the supply device and a similar coordinate system of the numerical unloading control are stored, wherein the machining product is configured to be supplied to the supply device for unloading with a position and an orientation defined in the coordinate system of the supply device, and wherein a position and an orientation of the machining product supplied for unloading in the coordinate system of the supply device can be derived from the position and the orientation of the machining product supplied for unloading in the similar coordinate system of the numerical unloading control by a calculation unit of the numerical control; and
an unloading member of the unloading device, which is movable with a transfer movement into a transfer position on the machining product supplied to the supply device for unloading, wherein the transfer movement of the unloading member is configured to be controlled by the numerical unloading control based on the position and the orientation of the machining product supplied for unloading in the coordinate system of the numerical unloading control, and wherein the machining product supplied by the supply device for unloading is configured to be transferred by the unloading member moved into the transfer position and the machining product transferred by the unloading member is configured to be unloaded from the supply device with an unloading movement of the unloading member,
wherein before the machining product is unloaded from the supply device, the numerical unloading control of the unloading device is configured to be calibrated, comprising: supplying a reference object to the supply device, which reference object has a marking that represents the coordinate system of the supply device and the position and the orientation of which are defined in the coordinate system of the supply device;
deriving a position and an orientation of the marking of the reference object supplied for unloading in the coordinate system of the numerical unloading control as a derived position and a derived orientation from the position and the orientation of the marking of the reference object supplied for unloading in the coordinate system of the supply device by the calculation unit of the numerical control;
representing the marking of the reference object supplied to the supply device for unloading in the coordinate system of the numerical unloading control by an acquisition device;
comparing the position and the orientation of the representation of the marking of the reference object in the coordinate system of the numerical unloading control with the derived position and the derived orientation of the marking of the reference object in the coordinate system of the numerical unloading control by a comparison unit of the numerical unloading control; and
adjusting the coordinate system of the numerical unloading control if the position and/or orientation of the representation of the marking of the reference object differs from the derived position or the derived orientation of the marking of the reference object in the coordinate system of the numerical unloading control, by bringing the derived position and/or the derived orientation of the marking of the reference object into agreement with the position or the orientation, respectively, of the representation of the marking of the reference object by means of an evaluation unit of the numerical unloading control,
wherein after calibrating the numerical unloading control of the unloading device, the position and the orientation of the machining product supplied for unloading in the adjusted coordinate system of the numerical unloading control can be derived from the position and the orientation of the machining product supplied for unloading in the coordinate system of the supply device by means of the calculation unit of the numerical control.

16. The mechanical unloading arrangement according to claim 15, wherein a separating device is provided, by which the marking of the reference object can be produced by separative machining of a reference object blank.

17. A mechanical manufacturing arrangement, comprising:
a machining device configured to machine a workpiece and produce a machining product; and
a mechanical unloading arrangement configured to unload the machining product of the workpiece machining process,
wherein the mechanical unloading arrangement according to claim 15 with the workpiece support as the supply device is provided as the mechanical unloading arrangement.

18. The mechanical manufacturing arrangement according to claim 17, wherein a laser separating device is provided as the machining device, by which the workpiece is configured to be subjected to separative machining, producing the machining product, and wherein the separating device is configured to be used to produce the reference object by using the separating device to produce the marking of the reference object on a reference object blank.

19. The mechanical manufacturing arrangement according to claim 17, wherein the mechanical manufacturing arrangement is designed for the separative machining of a section of a sheet metal strip unwound from a coil.
